(19) United States
(12) Patent Application Publication
(10) Pub. No.: US 2013/0263830 A1
(43) Pub. Date: Oct. 10, 2013

(54) EXHAUST GAS RECIRCULATION DEVICE

(71) Applicant: DENSO CORPORATION, Kariya-city (JP)

(72) Inventors: Katsuya TORII, Anjo-city (JP); Ryo SANO, Kariya-city (JP)

(73) Assignee: DENSO CORPORATION, Kariya-city (JP)

(21) Appl. No.: 13/859,091

(22) Filed: Apr. 9, 2013

(30) Foreign Application Priority Data
Apr. 9, 2012 (JP) 2012-88081

(51) Int. Cl. F02M 25/07

(52) U.S. Cl. CPC F02M 25/0771
USPC 123/568.11

(57) ABSTRACT

A rotational angle sensor for an EGR valve memorizes a correlated characteristic between hall voltage and output voltage. Hall voltage of the rotational angle sensor at a reference angle is matched to a boundary value for the hall voltage on a valve closing side, wherein the reference angle is set at such an angle, which is shifted by a predetermined angle in the valve closing side from an upper-limit angle of a flow-rate dead zone. A valve full-closing control is carried out in order that the hall voltage will coincide with the boundary value on the valve closing side. An actual value of the rotational angle coincides with a value, which is shifted from the reference angle in a valve closing or opening direction by a changing range decided by changing factors of a sensor side and/or a mechanical-part side.

### CROSS REFERENCE TO RELATED APPLICATION

This application is based on Japanese Patent Application No. 2012-088081 filed on Apr. 9, 2012, the disclosure of which is incorporated herein by reference.

### FIELD OF TECHNOLOGY

The present disclosure relates to an exhaust gas recirculation device (hereinafter, the EGR device) for re-circulating a part of exhaust gas of an internal combustion engine into an intake-air passage thereof.

### BACKGROUND

An EGR device is known in the art, for example, as disclosed in Japanese Patent Publication No. 2007-285173, according to which a nozzle having a cylindrical inner surface forms apart of a passage (an EGR passage) for exhaust gas to be recirculated (EGR gas) into an intake-air passage of an engine. A valve member is movably accommodated in the nozzle. A rotational angle sensor is provided for detecting a rotational angle of the valve member by a magneto-electric converting device. An amount of the EGR gas (the EGR amount) is controlled by an electronic control unit (hereinafter, the ECU) based on an output signal of the rotational angle sensor. The ECU is separately arranged from the rotational angle sensor.

When it is not necessary to recirculate the exhaust gas into the intake-air passage, the EGR device is operated in “a valve full-closing control” based on a command signal from the ECU, in which the EGR amount is controlled at a minimum value close to zero without limit. Various kinds of structures are applied to the EGR device in order to surely control the EGR amount at the minimum value, to thereby increase reliability for the valve full-closing control.

According to the above Patent Publication, an annular seal ring is provided at an outer periphery of the valve member, so that the seal ring slides on the cylindrical inner surface of the nozzle so as to seal a gap between the outer periphery of the valve member and the cylindrical inner surface when the EGR passage is closed. A dead zone for flow rate (hereinafter, the flow-rate dead zone) of the EGR gas is formed by elastic deformation of the seal ring, so that the EGR amount is controlled at the minimum value even when the valve member is rotated in a valve closing direction or a valve opening direction.

As shown in FIGS. 6A and 6B, when the seal ring slides on the cylindrical inner surface, a characteristic curve of the EGR amount has a convex shape downwardly projecting even in the flow-rate dead zone. Therefore, there exists a local minimum point, at which the EGR amount becomes at the minimum value. Accordingly, the flow-rate dead zone is defined as a predetermined angular range having the local minimum point at its center. In other words, the flow-rate dead zone is set as an acceptable range, for which the EGR amount can be regarded as zero.

A value of the rotational angle (hereinafter, the detected value or the detected value of the rotational angle), which is figured out by the ECU based on the output signal of the rotational angle sensor, differs from an actual value for the rotational angle due to temperature characteristics of the rotational angle sensor, abrasion of mechanical parts, change of shapes and so on. For example, a correlation curve in a case of no difference between the detected value and the actual value is indicated by a solid line “qx” in FIGS. 6A and 6B. A correlation curve in a case in which the detected value differs from the actual value in a valve closing direction is indicated by a dotted line “qy”. A correlation curve in a case in which the detected value differs from the actual value in a valve opening direction is indicated by another dotted line “qz”. Each of the correlation curves “qy” and “qz” corresponds to such a correlation curve, which is parallel-shifted from the correlation curve “qx” in a horizontal axis.

As a result, even when the detected value of the rotational angle is apparently within the flow-rate dead zone, the actual EGR amount may be such a value, which cannot be regarded as zero.

It is, therefore, necessary to take measures for surely bringing the EGR amount to the minimum value, even in a case that the detected value of the rotational angle differs from the actual value, to thereby increase the reliability for the valve full-closing control.

### SUMMARY OF THE DISCLOSURE

The present disclosure is made in view of the above point. It is an object of the present disclosure to provide an EGR device, according to which EGR amount can be surely controlled at a minimum value in an operation of a valve full-closing control, even when a detected value of a rotational angle sensor (for a rotational angle of a valve member) differs from an actual value.

According to a feature of the present disclosure, an EGR device of the present disclosure includes;

a valve member rotatably arranged in an EGR passage for opening and/or closing the EGR passage by its rotational movement so as to control an EGR amount to be recirculated into an intake-air passage of an engine;

an annular seal ring provided at an outer periphery of the valve member so that the annular seal ring is rotated together with the valve member, the annular seal ring being in a sliding contact with a passage wall surface in a predetermined angular range of the valve member in order to seal a gap between the outer periphery of the valve member and passage wall surface;

a cylindrical member having a sliding wall surface, which forms a part of the passage wall surface and which is in the sliding contact with the annular seal ring of the valve member; and

a rotational angle sensor having a magneto-electric converting device for generating an original signal depending on a rotational angle of the valve member and synthesizing an output signal from the original signal in order to output the output signal.

The sliding wall surface is formed with a spherical surface which is formed as a part of a spherical surface having a spherical center corresponding to a rotational center of the valve member, so that the cylindrical member forms a flow-rate dead zone for a predetermined rotational range of the valve member.

The rotational angle sensor memorizes a correlated characteristic between a signal value of the original signal and a signal value of the output signal, so that the rotational angle sensor synthesizes the output signal from the original signal by use of the correlated characteristic.

Each of the signal values of the original signal and the output signal has a boundary value for hall voltage on a valve closing side and a boundary value for output voltage on the valve closing side in connection with the correlated characteristic. The boundary value for the hall voltage on the valve closing side and the boundary value for the output voltage on the valve closing side are signal values of the original signal and the output signal in a condition in which the EGR amount is controlled at the minimum value. The signal value of the original signal and the signal value of the output signal correspond to each other in a one-to-one relationship in a range on a valve opening side of the boundary values.

A signal value of the original signal at a reference angle is matched to the boundary value for the hall voltage on the valve closing side of the original signal,

wherein the reference angle is set at such an angle, which is shifted by a predetermined angle in the valve closing side from an upper-limit angle of the dead zone, and

wherein the upper-limit angle of the dead zone corresponds to the rotational angle of the valve member at a most valve-opening side of the flow-rate dead zone.

According to the above feature, the operation for the valve full-closing control is carried out in such a manner that the signal value of the original signal coincides with the boundary value on the valve closing side. Therefore, the detected value of the rotational angle apparently coincides with the reference angle. The actual value of the rotational angle coincides with the angle, which is displaced from the reference angle either in the valve closing side or in the valve opening side by the changing range, which is decided by temperature characteristics of the rotational angle sensor, abrasion of mechanical parts, change of shapes and so on. Therefore, the reference angle is decided by taking into consideration the changing range (between the actual value and the detected value of the rotational angle), the signal value is measured at the reference angle, and signal value of the original signal at the reference angle is matched to the boundary value on the valve closing side. As a result, the actual value of the rotational angle can be surely moved to a position within the flow-rate dead zone, when the operation for the valve full-closing control is carried out. The EGR amount can be thereby controlled at the minimum value.

The sliding wall surface is formed as the part of the spherical surface having the spherical center, which coincides with the rotational center of the valve member. The EGR amount can be maintained at the minimum value within the angular range of the rotational angle, in which the seal ring is in contact with the sliding wall surface and slides on the same surface. As a result, the local minimum point for the EGR amount can be extinguished in the flow-rate dead zone and the EGR amount can be maintained at the minimum value, which is constant in the flow-rate dead zone and corresponds to the extremely small amount (close to zero without limit). Therefore, it is possible to easily adjust a width of the flow-rate dead zone by simply increasing or decreasing the length of the spherical surface. For example, even when it is supposed that the changing range for the detected value is larger, it is possible to surely move the actual value of the rotational angle to the position within the flow-rate dead zone by increasing the width of the dead zone. The EGR amount can be thereby controlled at the minimum value, when the operation for the valve full-closing control is carried out.

As above, even when the detected value differs from the actual value for the rotational angle of the valve member, the EGR amount can be controlled at the minimum value by the operation for the valve full-closing control.

### BRIEF DESCRIPTION OF THE DRAWINGS

The above and other objects, features and advantages of the present disclosure will become more apparent from the following detailed description made with reference to the accompanying drawings. In the drawings:

FIG. 1A is a schematic cross sectional view showing a structure of an EGR device according to an embodiment of the present disclosure;

FIG. 1B is an enlarged schematic view of a relevant portion of the EGR device of FIG. 1A;

FIG. 1C is a block diagram showing a flow of an electrical signal between the EGR device and an ECU;

FIG. 2 is a schematic front view showing a gear chamber of the EGR device;

FIG. 3A is a graph for a characteristic curve of an actual value showing a correlation between EGR amount and a rotational angle;

FIG. 3B is a graph for a characteristic curve showing a correlation between hall voltage and output voltage;

FIG. 4A is a graph for a characteristic curve showing a correlation between EGR amount and a detected value of a rotational angle;

FIG. 4B is a graph showing a characteristic curve showing a correlation between EGR amount and hall voltage;

FIG. 5 is an explanatory view showing an actual value for a rotational angle in an operation of a valve full-closing control;

FIG. 6A is a graph for characteristic curves showing a correlation between an EGR amount and a detected value of a rotational angle; and

FIG. 6B is an enlarged view showing a portion VIB of FIG. 6A.

### DETAILED DESCRIPTION OF THE EMBODIMENTS

An EGR device according to an embodiment of the present disclosure will be explained with reference to the drawings.

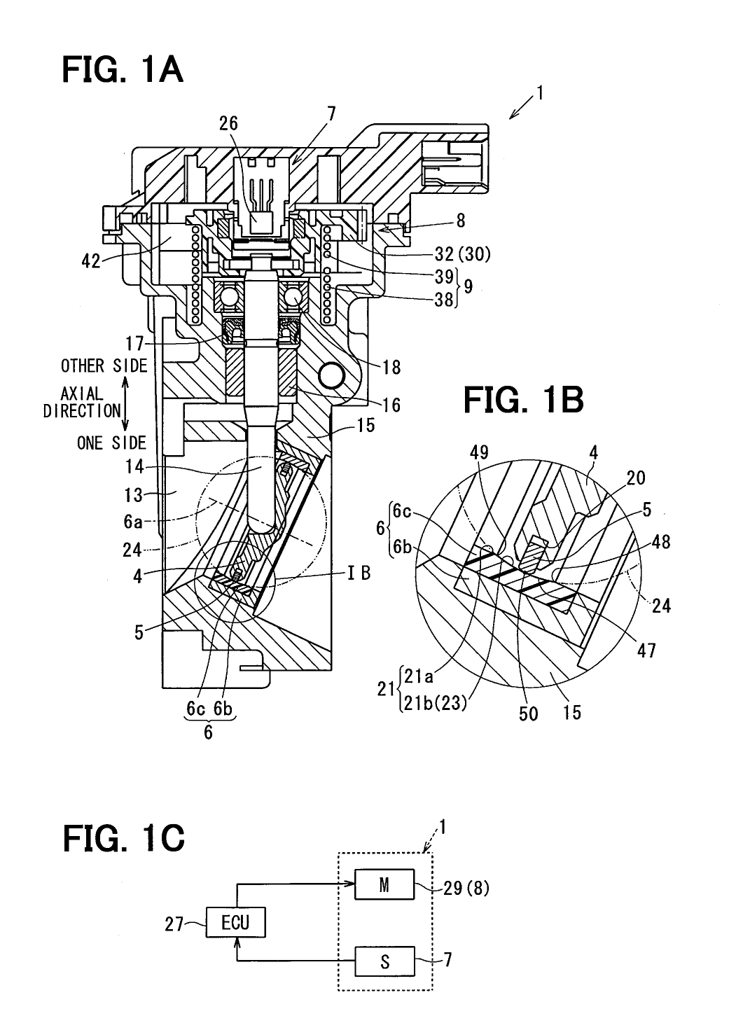

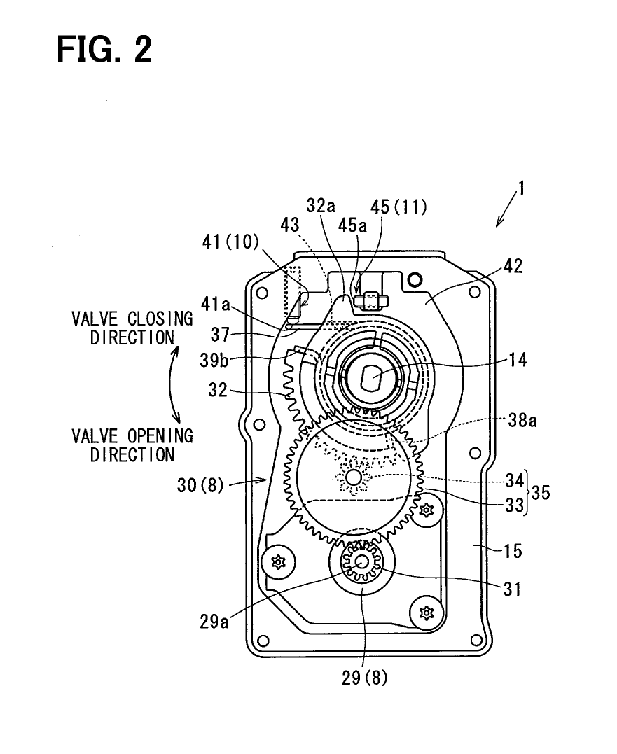

A structure of the EGR device 1 will be explained with reference to FIGS. 1 to 3.

The EGR device 1 recirculates a part of exhaust gas of an internal combustion engine (not shown) into an intake-air passage of the internal combustion engine (hereinafter, the engine), as EGR gas. The EGR device 1 is provided in an engine room of a vehicle and constitutes a part of an intake system and a part of an exhaust system of the engine.

The EGR device 1 is composed of a valve member 4, a seal ring 5, a nozzle 6, a rotational angle sensor 7, an actuator 8, a biasing member 9, an opener 10 and a stopper 11.

The valve member 4 is a butterfly valve formed in a disc shape having a certain thickness. The valve member 4 is movably provided in an EGR passage 13 for opening and closing the EGR passage 13. The valve member 4 is integrally fixed, for example, by welding, to a forward end of a rotational axis 14 in such a manner that the valve member 4 is inclined with respect to the rotational axis 14 so that the valve member 4 and the rotational axis 14 form an acute angle between them. The rotational axis 14 is rotatably supported by a metal bearing 16, an oil seal 17 and a ball bearing 18, which are assembled to a housing 15 of the EGR device 1.

The seal ring 5 is, for example, formed in a C-letter shape. More exactly, the seal ring 5 is formed in an almost annular shape having circumferential ends, which form an abutment joint (not shown) between the circumferential ends. A fitting groove 20 is formed at an outer periphery of the valve member 4. The seal ring 5 is fitted into the fitting groove 20 and rotated together with the valve member 4. When the valve member 4 is rotated to close the EGR passage 13, the seal ring 5 slides on a passage wall surface 21 so as to seal an annular gap formed between the outer periphery of the valve member 4 and the passage wall surface 21. In the above movement, the seal ring 5 is elastically deformed by making a circumferential gap of the abutment joint smaller and in a sliding contact with the passage wall surface 21.

The nozzle 6 is formed in a cylindrical shape for movably accommodating the valve member 4. The nozzle 6 is press-fitted into the housing 15. The nozzle 6 has a sliding wall surface 23 forming a part of the EGR passage 13. An inner wall surface (the passage wall surface 21) of the nozzle 6 is composed of a cylindrical surface portion 21a and a spherical surface portion 21b, which is recessed in a radial outward direction. The spherical surface portion 21b forms the sliding wall surface 23. The sliding wall surface 23 is formed as a part of a spherical surface 24 having a center corresponding to a rotational center of the valve member 4.

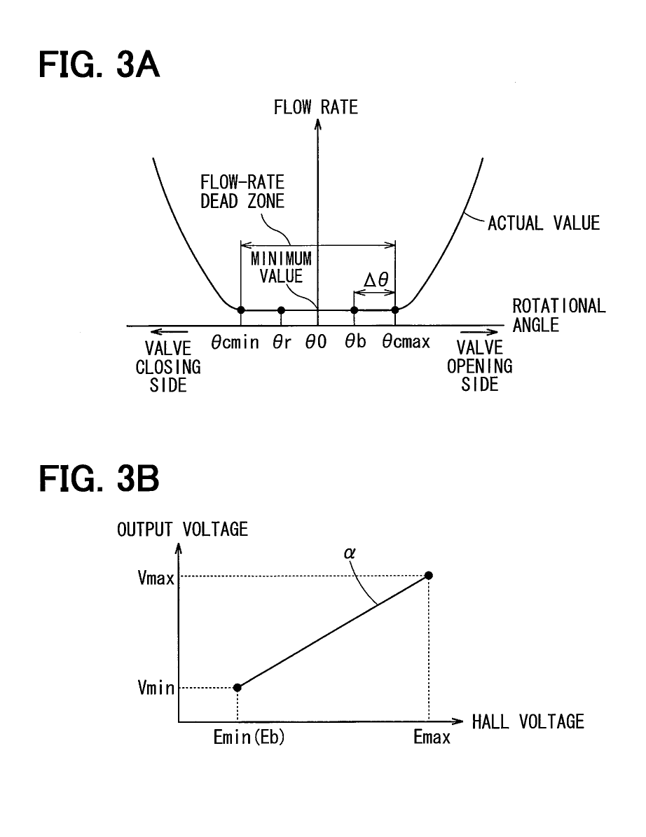

According to the above structure, even when the valve member 4 is rotated either in a valve closing direction or in a valve opening direction within a predetermined angular range, in which the valve member 4 is in the sliding contact with the sliding wall surface 23, an amount of the EGR gas (the EGR amount) passing through the nozzle 6 coincides with a minimum value, which is close to zero without limit. As above, there exists a flow-rate dead zone for the rotational angle of the valve member 4, in which the EGR amount is controlled at the minimum value even when the valve member 4 is rotated in the valve closing direction or in the valve opening direction (FIG. 3A). The predetermined angular range for the flow-rate dead zone is defined by an area of the sliding wall surface 23 (the area of the spherical surface portion 21b) and so on.

The nozzle 6 is composed of an outer ring member 6b made of metal and an inner ring member 6c made of resin and press-inserted into an inner periphery of the outer ring member 6b. Each of the outer ring member 6b and the inner ring member 6c is formed in a cylindrical shape. An inner peripheral surface of the inner ring member 6c forms a part of the passage wall surface 21. The sliding wall surface 23 is formed at the inner peripheral surface of the inner ring member 6c. The valve member 4 as well as the outer ring member 6b is made of, for example, stainless steel in view of heat resistance, corrosion resistance and the like. The housing 15 is made of, for example, aluminum alloy in view of weight saving and the like. The inner ring member 6c is made of, for example, polyimide resin in view of heat resistance, corrosion resistance and so on.

Since the inner ring member 6c is made of the resin, abrasion to be caused by the sliding contact between the seal ring 5 and the sliding wall surface 23 can be suppressed. In addition, since the outer ring member 6b made of the metal is interposed between the inner ring member 6c and the housing 15, a transfer of strain caused by thermal deformation of the housing 15 to the inner ring member 6c can be suppressed. As a result, deformation of the spherical portion 21b can be suppressed.

Instead of separately forming the nozzle 6 from the housing 15, the nozzle 6 can be integrally formed with the housing 15 as a part thereof.

The rotational angle sensor 7 is composed of a magneto-electric converting device 26 for generating an original signal depending on a rotational angle of the valve member 4 and synthesizing an output signal from the original signal in order to output the output signal. The magneto-electric converting device 26 is, for example, a hall IC for generating the original signal depending on hall voltage. In other words, the rotational angle sensor 7 has a magnetic-flux generating unit (not shown), such as a permanent magnet, rotated together with the rotational axis 14. The magneto-electric converting device 26 generates the hall voltage depending on the magnetic flux generated by the magnetic-flux generating unit and synthesizes the output signal from the original signal.

The output signal of the rotational angle sensor 7 is inputted to an electronic control unit 27 (the ECU 27) for controlling an operation of the engine. The ECU 27 figures out the rotational angle of the valve member 4 based on the output signal of the rotational angle sensor 7 and transmits a command signal to the actuator 8 based on the figured-out value for the rotational angle (the detected value of the rotational angle), so as to control a rotational movement of the valve member 4.

The rotational angle sensor 7 memorizes a correlated characteristic “α” (FIG. 3B) between a signal value of the original signal and a signal value of the output signal (that is, a correlated characteristic between the hall voltage and the output voltage). The rotational angle sensor 7 synthesizes the output signal from the original signal by use of the correlated characteristic “α”. As shown in FIG. 3B, the correlated characteristic “α” is preset so that the correlation between the hall voltage and the output voltage becomes linear. More exactly, the correlated characteristic “α” has a boundary value “Emin” for the hall voltage on a valve closing side and a boundary value “Vmin” for the output voltage on the valve closing side. The boundary values “Emin” and “Vmin” respectively correspond to the hall voltage and the output voltage, when the valve member 4 is in its fully closed position so that the EGR amount becomes the minimum value. In a similar manner, the correlated characteristic “α” has a boundary value “Emax” for the hall voltage on a valve opening side and a boundary value “Vmax” for the output voltage on the valve opening side. The boundary values “Emax” and “Vmax” respectively correspond to the hall voltage and the output voltage, when the valve member 4 is in its fully opened position so that the EGR amount becomes the maximum value. The output voltage linearly changes from “Vmin” to “Vmax” with respect to the hall voltage in a range between the “Emin” and “Emax”.

As shown in FIG. 3A, the flow-rate dead zone exists in the angular range between “θcmin” and “θcmax”. The rotational angle “θcmax”, which is located at a most valve-opening side within the flow-rate dead zone, is called as an upper-limit angle “θcmax” of the dead zone. The rotational angle “θcmin”, which is located at a most valve-closing side within the flow-rate dead zone, is called as a lower-limit angle “θcmin” of the dead zone.

A rotational angle “θb”, which is distanced from the upper-limit angle “θcmax” of the dead zone in the valve closing direction by a predetermined angle “Δθ”, is called as a reference angle. The hall voltage at the reference angle “θb” corresponds to the boundary value “Emin” for the hall voltage on the valve closing side. The boundary value “Emin” is also referred to as a reference value “Eb”. The boundary value “Emin” (the reference value “Eb”) for the hall voltage on the valve closing side and the boundary value “Emax” for the hall voltage on the valve opening side are measured according to predetermined conditions before the EGR device 1 is installed in the vehicle.

The rotational angle sensor 7 is provided at an axial end of the rotational axis 14 (at an upper side in FIG. 1A) opposite to the valve member 4. In the present application, a direction of the rotational axis 14 is referred to as an axial direction, an axial end of the rotational axis 14 (a lower end in FIG. 1A) is referred to as one end (or one side), the other axial end of the rotational axis 14 (an upper end in FIG. 1A) is referred to as the other end (or the other side).

The actuator 8 has an electric motor 29 for generating a rotational torque for rotating the valve member 4 and a speed decreasing unit 30 for amplifying the rotational torque generated at the electric motor 29 and transmitting the amplified rotational torque to the valve member 4.

The electric motor 29 is rotated in a forward direction or in a backward direction in accordance with the command signal from the ECU 27. The ECU 27 outputs the command signal to the electric motor 29 based on the detected value of the rotational angle, so that the valve member 4 is rotated either in the valve opening direction or in the valve closing direction.

The speed decreasing unit 30 is composed of a motor gear 31 fixed to an output shaft 29a of the electric motor 29, a valve gear 32 fixed to the other end of the rotational axis 14 so that the valve gear 32 is rotated together with the valve member 4 and the rotational axis 14, and an intermediate gear 35 provided between the motor gear 31 and the valve gear 32. The intermediate gear 35 has a large-diameter gear 33 engaged with the motor gear 31 and a small-diameter gear 34 engaged with the valve gear 32, which are coaxially arranged to each other.

The biasing member 9 is composed of two (first and second) torsion springs 38 and 39, which are connected by a U-shaped hook 37 to each other. Each of the torsion springs 38 and 39 is twisted in a direction opposite to each other and coaxially arranged with the rotational axis 14. One end 38a (a lower end) of the first torsion spring 38 is hooked to the housing 15, while the other end (an upper end) of the first torsion spring 38 is connected to the hook 37. One end (a lower end) of the second torsion spring 39 is connected to the hook 37, while the other end 39b (an upper end) of the second torsion spring 39 is hooked to the valve gear 32, so that the other end 39b of the second torsion spring 39 is rotated together with the valve gear 32.

As explained more in detail below, in a first angular range, in which the rotational angle is larger than the reference angle “θb” in the valve opening side, the first torsion spring 38 biases the valve member 4 and its related parts in the valve closing direction by function of the opener 10. On the other hand, in a second angular range, in which the rotational angle is positioned on the valve closing side from the reference angle “θb”, the second torsion spring 39 biases the valve member 4 and its related parts in the valve opening direction.

The opener 10 releases the valve member 4 from the rotational biasing force of the first torsion spring 38 in the second angular range, that is, when the rotational angle is located on the valve closing side from the reference angle “θb”. The opener 10 is composed of a bolt 41 screwed into the housing 15. The bolt 41 is screwed into the housing 15 in such a way that a forward end 41a of the bolt 41 projects into a gear chamber 42, in which the speed decreasing unit 30 is accommodated. A screwed amount of the bolt 41 is so adjusted that the hook 37 is brought into contact with the forward end 41a of the bolt 41, when the valve member 4 is about to be further rotated in the valve closing direction beyond the reference angle “θb”.

As a result, a biasing condition to the valve member 4 by the first and the second torsion springs 38 and 39 is changed in the first and the second angular ranges with the boundary of the reference angle “θb”.

In the first angular range in which the rotational angle is located on the valve opening side from the reference angle “θb”, the hook 37 is in contact with a hook lever 43 formed in the valve gear 32, so that the hook 37 is rotated together with the valve member 4. Since the one end 38a (the lower end) of the first torsion spring 38 is fixed to the housing 15, while the other end (the upper end) of the first torsion spring 38, that is, the hook 37 is rotated together with the valve gear 32, the rotational biasing force of the first torsion spring 38 is transmitted to the valve member 4 via the engagement between the hook 37 and the hook lever 43 of the valve gear 32. Accordingly, the valve member 4 is biased in the valve closing direction. In this situation (that is, in the first angular range), both ends of the second torsion spring 39 are held by the valve gear 32, so that the rotational biasing force is not applied from the second torsion spring 39 to the valve member 4.

On the other hand, in the second angular range in which the rotational angle is located on the valve closing side from the reference angle “θb”, since the hook 37 is brought into contact with the forward end 41a of the bolt 41, the movement of the hook 37 (that is, the movement of the first torsion spring 38) is stopped relative to the valve member 4. In this situation, both ends of the first torsion spring 38 are held by the housing 15 and the rotational biasing force is not applied from the first torsion spring 38 to the valve member 4. In other words, the valve member 4 is released from the rotational biasing force of the first torsion spring 38 in the second angular range.

In the second angular range, the one end of the second torsion spring 39 (that is, the hook 37) is held by the housing 15 via the bolt 41, while the other end 39b of the second torsion spring 39 is rotated together with the valve gear 32. As a result, the rotational biasing force of the second torsion spring 39 is applied to the valve member 4 via the engagement between the other end 39b and the valve gear 32. Accordingly, the valve member 4 is biased in the valve opening direction.

In the present embodiment, the bolt 41 is used as the opener 10. However, a portion of the housing 15 may be used as the opener 10, so that the portion of the housing 15 (the opener 10) is brought into contact with the hook 37. In such a modification, an adjustment for the engagement between the opener 10 and the hook 37 at the reference angle “θb” can be done, when the valve member 4 is fixed to the rotational axis 14 by welding.

The stopper 11 restricts the further movement of the valve member 4 in the valve closing direction beyond a restricting angle “θr”, which is located at such a rotational angle shifted in the valve closing direction from the reference angle “θb”, as shown in FIG. 3A. The stopper 11 is composed of a bolt 45, which is screwed into the housing 15. In a similar manner to the bolt 41, the bolt 45 is screwed into the housing 15 in such a way that a forward end 45a of the bolt 45 projects into the gear chamber 42. A screwed amount of the bolt 45 is so adjusted that the valve gear 32 is brought into contact with the forward end 45a of the bolt 45, when the valve member 4 is about to be further rotated in the valve closing direction beyond the restricting angle “θr”.

The valve gear 32 has a projection 32a projecting in a radial outward direction. The projection 32a is brought into contact with the forward end 45a of the bolt 45 at the restricting angle “θr” so as to restrict the further rotation of the valve gear 32 in the valve closing direction.

As shown in FIG. 3A, the restricting angle “θr” is set at such a rotational angle in an angular range between the lower-limit angle “θcmin” of the dead zone and an intermediate angle “θ0” of the dead zone.

The intermediate angle “θ0” corresponds to a center angle of the flow-rate dead zone, that is, an arithmetic average of the upper-limit angle “θcmax” of the dead zone and the lower-limit angle “θcmin” of the dead zone.

The intermediate angle “θ0” corresponds to the rotational angle of the valve member 4, when the valve member 4 is moved to a position at which the valve member 4 is perpendicular to a passage center line 6a of the nozzle 6 for closing the EGR passage 13.

Since the restricting angle “Or” is set at the angle on the valve closing side of the intermediate angle “θ0”, the valve member 4 is allowed to be further rotated from the intermediate angle “θ0” in the valve closing direction. It is, therefore, possible to sweep out deposit attached to the seal ring 5 and/or the sliding wall surface 23.

In the present embodiment, the bolt 45 is used as the stopper 11. However, a portion of the housing 15 may be used as the stopper 11, so that the portion of the housing 15 (the stopper 11) is brought into contact with the projection 32a. In such a modification, an adjustment for the engagement between the stopper 11 and the projection 32a at the restricting angle “θr” can be done, when the valve member 4 is fixed to the rotational axis 14 by welding.

In the above EGR device 1, the sliding wall surface 23 is designed in the following manner in connection with the angular range of the flow-rate dead zone (the angular range between the upper-limit angle “θcmax” of the dead zone and the lower-limit angle “θcmin” of the dead zone).

The detected value of the rotational angle differs from the actual value depending on not only changing factors of the sensor side, for example, the temperature characteristics of the rotational angle sensor 7 but also changing factors of the mechanical-parts side, for example, the abrasion and/or deformation of the parts for the speed decreasing unit 30, the opener 10, the stopper 11 and so on. Accordingly, the angular range of the flow-rate dead zone is set as the angular range, which is larger than a changing range of the detected value depending on the changing factors of the sensor side and the mechanical-parts side.

In FIG. 1B, a cutting-plane line 47 of the sliding wall surface 23 is shown. The cutting-plane line 47 is a line on a cutting plane of the nozzle 6 including the passage center line 6a. Since the sliding wall surface 23 corresponds to the spherical surface portion 21b, the cutting-plane line 47 is an arc line. A length of the arc becomes longer, as the angular range of the flow-rate dead zone is made larger. More exactly, the length of the arc is equal to a value, which is calculated by multiplying the angular range of the flow-rate dead zone by a radius of rotation of the seal ring 5 (that is, a radius of the spherical surface 24).

An intermediate point 50 is a point on the cutting-plane line 47 between an upstream-side point 48 and a downstream-side point 49, both of which are also located on the cutting-plane line 47. A length of the arc between the intermediate point 50 and the upstream-side point 48 (or the downstream-side point 49) is a half of the length of the arc for the spherical surface portion 21b. The intermediate point 50 is set as a position, at which the seal ring 5 is in contact with the spherical surface portion 21b when the actual value of the rotational angle comes to the intermediate angle “θ0”. Then, the length of the arc between the intermediate point 50 and the upstream-side point 48 as well as the length of the arc between the intermediate point 50 and the downstream-side point 49 is set as such a value, which is larger than a value calculated by an angle corresponding to the changing range of the detected value (which depends on the changing factors of the sensor side and the mechanical-parts side) by the radius of the spherical surface 24.

The above changing range of the detected value is a maximum value (the maximum changing range “max”) among changing ranges estimated based on the changing factors of the sensor side and the mechanical-parts side.

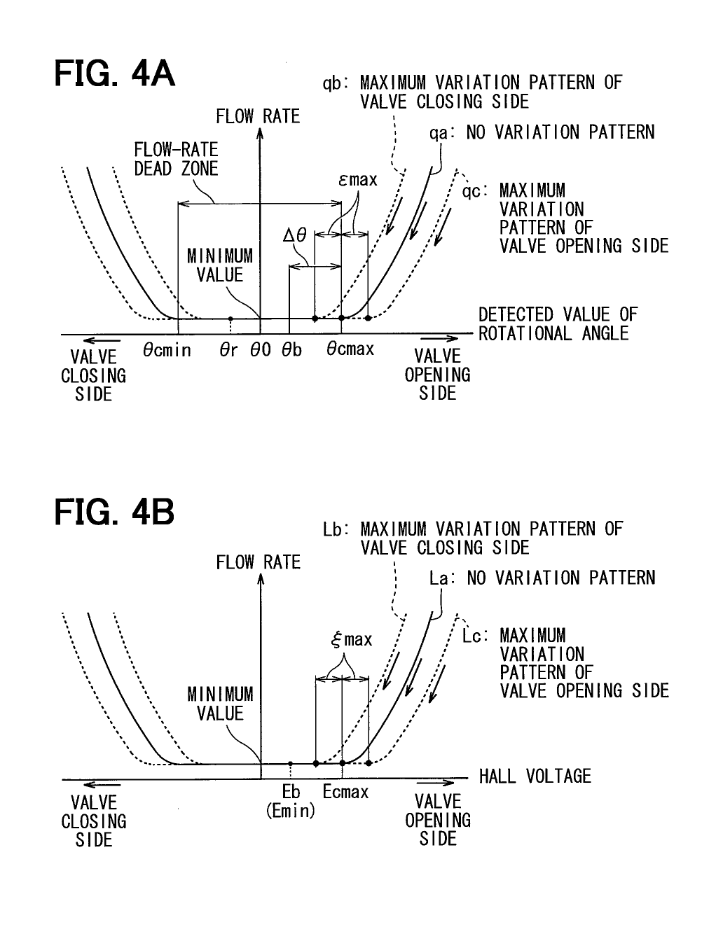

In the EGR device 1, since the detected value of the rotational angle differs from the actual value due to the changing factors of the sensor side and the mechanical-parts side, a correlation between the detected value of the rotational angle and the EGR amount varies, as shown in FIG. 4A.

In FIG. 4A, a correlation line “qa” shows a correlation between the actual value of the rotational angle and the EGR amount (the flow rate), namely the correlation when the detected value of the rotational angle does not differ from the actual value.

A correlation line “qb” shows a correlation, when the detected value of the rotational angle is changed from the actual value in the valve closing direction by the maximum changing range “max”. The correlation line “qb” coincides with the correlation line “qa”, when the correlation line “qa” is parallel-shifted in the valve closing direction by the maximum changing range “max”.

A correlation line “qc” shows a correlation, when the detected value of the rotational angle is changed from the actual value in the valve opening direction by the maximum changing range “max”. The correlation line “qc” coincides with the correlation line “qa”, when the correlation line “qa” is parallel-shifted in the valve opening direction by the maximum changing range “εmax”.

Hereinafter, a variation pattern of the detected value, in which the detected value does not differ from the actual value, namely, the variation pattern of the detected value of the correlation line “qa” is referred to as a no-variation pattern.

The variation pattern of the detected value, in which the detected value is parallel-shifted from the actual value in the valve closing direction by the maximum changing range “max”, namely, the variation pattern of the detected value of the correlation line “qb” is referred to as a maximum variation pattern of the valve closing side.

The variation pattern of the detected value, in which the detected value is parallel-shifted from the actual value in the valve opening direction by the maximum changing range “εmax”, namely, the variation pattern of the detected value of the correlation line “qc” is referred to as a maximum variation pattern of the valve opening side.

When the detected value differs from the actual value, the correlation between the hall voltage and the EGR amount (the flow rate) varies, as shown in FIG. 4B.

In FIG. 4B, a correlation line “La” shows a correlation between the hall voltage and the EGR amount at the no-variation pattern. Namely, the correlation line “La” corresponds to the correlation line “qa”. A correlation line “Lb” shows a correlation between the hall voltage and the EGR amount at the maximum variation pattern of the valve closing side. Namely, the correlation line “Lb” corresponds to the correlation line “qb”. In a similar manner, a correlation line “Lc” shows a correlation between the hall voltage and the EGR amount at the maximum variation pattern of the valve opening side. Namely, the correlation line “Lc” corresponds to the correlation line “qc”.

A hall voltage value at such a point of the correlation line “La”, at which the EGR amount is about to increase in the angular range of the valve opening side of the intermediate angle “θ0”, is called as an upper-limit voltage “Ecmax” of the dead zone. The upper-limit voltage “Ecmax” of the dead zone corresponds to the upper-limit angle “θcmax” of the dead zone. A changing range for the hall voltage, which corresponds to the maximum changing range “εmax” for the detected value, is called as a maximum changing range “ξmax” for the hall voltage.

In the EGR device 1, when it is not necessary to recirculate the exhaust gas into the intake-air passage, the EGR device 1 is operated in “a valve full-closing control” based on the command signal from the ECU 27, in which the EGR amount is controlled at the minimum value close to zero without limit.

In other words, the ECU 27 controls power supply to the electric motor 29 in such a manner that the output voltage of the rotational angle sensor 7 coincides with the boundary value “Vmin” for the output voltage on the valve closing side (namely, the hall voltages coincides with the boundary value “Emin” for the hall voltage on the valve closing side), so as to realize such an operating condition of the engine in which the EGR amount is minimized.

As explained above, the boundary value “Emin” for the hall voltage on the valve closing side corresponds to the reference value “Eb”. Therefore, when the operation for the valve full-closing control is carried out, the valve member 4 is rotated in the valve closing direction until the hall voltage becomes to the value equal to the reference value “Eb”. Since the reference value “Eb” is the hall voltage at the reference angle “θ0”, the detected value of the rotational angle is apparently changed until the detected value coincides with the reference angle “θ0”, when the operation for the valve full-closing control is carried out.

When the operation for the valve full-closing control is carried out in the no-variation pattern of the detected value in order to rotate the valve member 4 in the valve closing direction, the detected value of the rotational angle and the hall voltage change as below (the current position of the valve member 4 is supposed to be located at a right-most position on the solid line “qa” and “La” in FIGS. 4A and 4B):

At first, each of the detected value of the rotational angle and the hall voltage is decreased along the respective correlation lines “qa” and “La” in the valve closing direction, as the EGR amount (the flow rate) is decreased, as indicated by an arrow. When the EGR amount reaches at its minimum value, the hall voltage reaches at the upper-limit voltage “Ecmax” of the dead zone, while the detected value of the rotational angle apparently reaches at the upper-limit angle “θcmax” of the dead zone.

Then, the valve member 4 is further rotated in the valve closing direction by the predetermined angle “Δθ”. During this rotation of the valve member 4, the EGR amount is maintained at its minimum value, while the hall voltage reaches at the reference value “Eb” and the detected value of the rotational angle apparently reaches at the reference angle “θb”.

When the operation for the valve full-closing control is carried out in the maximum variation pattern (of the detected value) of the valve closing side in order to rotate the valve member 4 in the valve closing direction, the detected value of the rotational angle and the hall voltage change as below (the current position of the valve member 4 is supposed to be located at a right-most position on the dotted line “qb” and “Lb” in FIGS. 4A and 4B):

At first, each of the detected value of the rotational angle and the hall voltage is decreased along the respective correlation lines “qb” and “Lb” in the valve closing direction, as the EGR amount (the flow rate) is decreased, as indicated by an arrow. When the EGR amount reaches at its minimum value, the hall voltage reaches at such a voltage, which is shifted to the valve closing side of the upper-limit voltage “Ecmax” of the dead zone by the maximum changing range “max” for the hall voltage (the hall voltage=“Ecmax”−“ξmax”). In addition the detected value of the rotational angle apparently reaches at such a voltage, which is shifted to the valve closing side of the upper-limit angle “θcmax” of the dead zone by the maximum changing range “εmax” for the detected value (the detected value=“θcmax”−“εmax”).

Then, the valve member 4 is further rotated in the valve closing direction by such a value, which is calculated by subtracting the maximum changing range “εmax” from the predetermined angle “Δθ” (that is, the value=“Δθ”−“εmax”). During this rotation of the valve member 4, the EGR amount is maintained at its minimum value, while the hall voltage reaches at the reference value “Eb” and the detected value of the rotational angle apparently reaches at the reference angle “θb”.

In addition, when the operation for the valve full-closing control is carried out at the maximum variation pattern (of the detected value) of the valve opening side in order to rotate the valve member 4 in the valve closing direction, the detected value of the rotational angle and the hall voltage change as below (the current position of the valve member 4 is supposed to be located at a right-most position on the dotted line “qc” and “Lc” in FIGS. 4A and 4B):

At first, each of the detected value of the rotational angle and the hall voltage is decreased along the respective correlation lines “qc” and “Lc” in the valve closing direction, as the EGR amount (the flow rate) is decreased, as indicated by an arrow. When the EGR amount reaches at its minimum value, the hall voltage reaches at such a voltage, which is shifted to the valve opening side of the upper-limit voltage “Ecmax” of the dead zone by the maximum changing range “max” for the hall voltage (the hall voltage=“Ecmax”+“ξmax”). In addition the detected value of the rotational angle apparently reaches at such a voltage, which is shifted to the valve opening side of the upper-limit angle “θcmax” of the dead zone by the maximum changing range “εmax” for the detected value (the detected value=“θcmax”+“εmax”).

Then, the valve member 4 is further rotated in the valve closing direction by such a value, which is calculated by adding the maximum changing range “εmax” to the predetermined angle “Δθ” (that is, the value=“Δθ”+“εmax”). During this rotation of the valve member 4, the EGR amount is maintained at its minimum value, while the hall voltage reaches at the reference value “Eb” and the detected value of the rotational angle apparently reaches at the reference angle “θb”.

The predetermined angle “Δθ” is made to be larger than the maximum changing range “εmax”, so that the EGR amount can be surely controlled at the minimum value when the operation for the valve full-closing control is carried out at the maximum variation pattern (of the detected value) of the valve closing side. The reference angle “θb” is set at such an angle, which is further on the valve closing side from the angular point of “θcmax”−“εmax”, that is, the angular point shifted in the valve closing direction from the upper-limit angle “θcmax” of the dead zone by the maximum changing range “εmax” for the detected value.

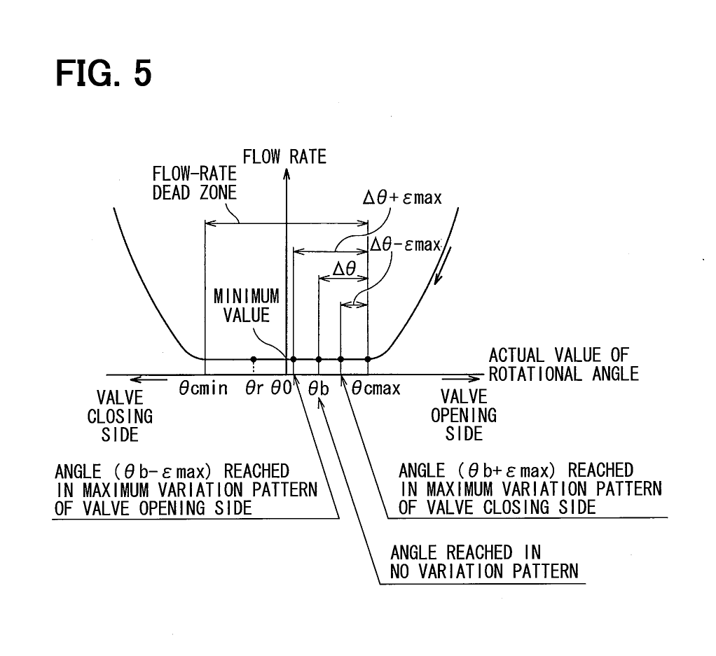

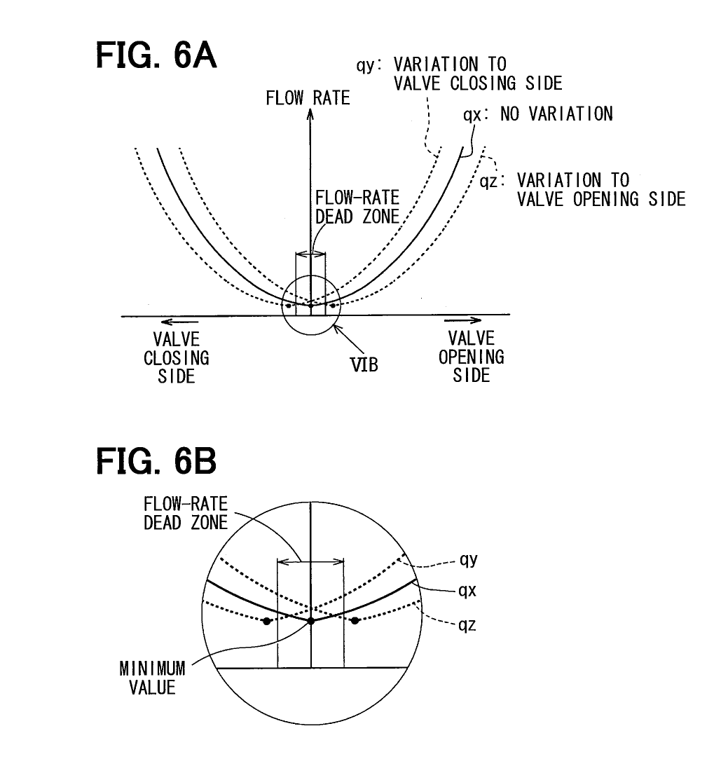

According to the above structure, as shown in FIG. 5, when the operation for the valve full-closing control is carried out, the actual value of the rotational angle moves to the flow-rate dead zone and the EGR amount is controlled at the minimum value, independently how the detected value of the rotational angle differs from the actual value (so long as the detected value differs from the actual value within the scope of the assumption, that is, the maximum changing range “εmax”).

Namely, when the operation for the valve full-closing control is carried out, the actual value of the rotational angle reaches at the upper-limit angle “θcmax” of the dead zone irrespectively of the apparent detected value, so that the valve member 4 is rotated to its fully closed position and thereby the EGR amount is minimized. In addition, the valve member 4 is further rotated in the valve closing direction, even after the actual value of the rotational angle has reached at the upper-limit angle “θcmax” of the dead zone (even after the EGR amount is controlled at the minimum value). The actual value of the rotational angle is moved in the valve closing direction to such an angular position, which is decided depending on the changing range of the detected value.

The actual value of the rotational angle in the no-variation pattern of the detected value reaches at the angle, which is shifted in the valve closing direction from the upper-limit angle “θcmax” of the dead zone by the predetermined angle “Δθ”, that is, the angle of “θcmax”−“Δθ”.

The actual value of the rotational angle in the maximum variation pattern (of the detected value) of the valve closing side reaches at the angle, which is shifted in the valve closing direction from the upper-limit angle “θcmax” of the dead zone by the angular range (“Δθ”−“εmax”). The angular range (“Δθ”−“εmax”) corresponds to the value obtained by subtracting the maximum changing range “εmax” from the predetermined angle “Δθ”.

The actual value of the rotational angle in the maximum variation pattern (of the detected value) of the valve opening side reaches at the angle, which is shifted in the valve closing direction from the upper-limit angle “θcmax” of the dead zone by the angular range (“Δθ”+“εmax”). The angular range (“Δθ”+“εmax”) corresponds to the value obtained by adding the maximum changing range “εmax” to the predetermined angle “Δθ”.

As shown in FIG. 5, not only the angle (“θb”+“εmax”), at which the actual value of the rotational angle reaches in the case of the maximum variation pattern (of the detected value) of the valve closing side, but also the angle (“θb”−“εmax”), at which the actual value of the rotational angle reaches in the case of the maximum variation pattern (of the detected value) of the valve opening side, is located within the flow-rate dead zone. Accordingly, when the operation for the valve full-closing control is carried out, the actual value of the rotational angle surely moves to the position within the flow-rate dead zone and the EGR amount is controlled at the minimum value, independently how the detected value of the rotational angle differs from the actual value (so long as the detected value differs from the actual value within the scope of the assumption).

The EGR device 1 of the above explained embodiment has the following advantages:

(1) According to the above EGR device 1, the sliding wall surface 23 is formed as a part of the spherical surface 24 having the spherical center, which coincides with the rotational center of the valve member 4 and thereby the flow-rate dead zone is formed for the certain angular range of the valve member 4.

The rotational angle sensor 7 memorizes the correlated characteristic “α” between the hall voltage and the output voltage. The reference value “Eb” (that is, the hall voltage at the reference angle “θb”, which is distanced from the upper-limit angle “θcmax” of the dead zone in the valve closing direction by the predetermined angle “Δθ”) is matched to the boundary value “Emin” for the hall voltage on the valve closing side.

As a result, the operation for the valve full-closing control is carried out in such a manner that the hall voltage coincides with the boundary value “Emin” for the hall voltage on the valve closing side (that is, the reference value “Eb”) (FIG. 4B). When the operation for the valve full-closing control is carried out, the detected value of the rotational angle apparently coincides with the reference angle “θb” (FIG. 4A). The actual value of the rotational angle coincides with the angle, which is displaced from the reference angle “θb” either in the valve closing side or in the valve opening side by the changing range of the detected value depending on the changing factors of the sensor side and the mechanical-parts side (FIG. 5). Therefore, according to the above embodiment, the reference angle “θb” is decided by taking into consideration the changing range (between the actual value and the detected value of the rotational angle), the hall voltage is measured at the reference angle “θb”, and the hall voltage at the reference angle “θb” is matched to the boundary value “Emin” for the hall voltage on the valve closing side. As a result, the actual value of the rotational angle can be surely moved to the position within the flow-rate dead zone, when the operation for the valve full-closing control is carried out. The EGR amount can be thereby controlled at the minimum value.

(2) The sliding wall surface 23 is formed as the part of the spherical surface 24 having the spherical center, which coincides with the rotational center of the valve member 4 (FIG. 1B). The EGR amount can be maintained at the minimum value within the angular range of the rotational angle, in which the seal ring 5 is in contact with the sliding wall surface 23 and slides on the same surface 23. As a result, the local minimum point for the EGR amount can be extinguished in the flow-rate dead zone and the EGR amount can be maintained at the minimum value, which is constant in the flow-rate dead zone and corresponds to the extremely small amount (close to zero without limit). Therefore, it is possible to easily adjust a width of the flow-rate dead zone by simply increasing or decreasing the length of the arc of the cutting-plane line 47. For example, even when it is supposed that the changing range for the detected value is larger, it is possible to surely move the actual value of the rotational angle to the position within the flow-rate dead zone by increasing the width of the dead zone. The EGR amount can be thereby controlled at the minimum value, when the operation for the valve full-closing control is carried out.

As above, even when the detected value differs from the actual value for the rotational angle of the valve member 4, the EGR amount can be controlled at the minimum value by the operation for the valve full-closing control.

(3) In addition, the opener 10 (the bolt 41) releases the valve member 4 from the rotational biasing force of the first torsion spring 38 in the valve closing direction, when the actual value of the rotational angle is positioned at the angle, which is on the valve closing side of the reference angle “θb”.

Accordingly, the opener 10 releases the valve member 4 from the rotational biasing force of the first torsion spring 38 in the valve closing direction, when the actual value of the rotational angle reaches at the reference angle “θb” in the operation for the valve full-closing control. It is, therefore, possible to suppress the abrasion and/or deformation of the related mechanical parts, which may be caused by a backlash when the valve member 4 is driven to rotate again in the valve opening direction after the operation for the valve full-closing control.

(4) In addition, the stopper 11 (the bolt 45) restricts the further rotation of the valve member 4 in the valve closing direction beyond the restricting angle “θr”, which is set at the angle on the valve closing side of the reference angle “θb”.

In other words, the stopper 11 does not restrict but allows the further rotation of the valve member 4 in the valve closing direction beyond the reference angle “θb)”, even when the actual value of the rotational angle reaches at the reference angle “θb” in the operation for the valve full-closing control. Accordingly, it is avoided that the valve gear 32 strikes against the stopper 11 in the operation for the valve full-closing control, to thereby suppress the abrasion and/or deformation of the related mechanical parts.

The restricting angle “θr” is set at the angle on the valve closing side of the angle (“θb“−”εmax”), at which the actual value of the rotational angle reaches in the case of the maximum variation pattern (of the detected value) of the valve opening side (FIG. 5).

Therefore, it is possible to prevent the valve gear 32 from striking against the stopper 11 in the operation for the valve full-closing control, independently how the detected value of the rotational angle differs from the actual value (so long as the detected value differs from the actual value within the scope of the assumption).

### (Modifications)

The present disclosure should not be limited to the above embodiment but may be modified in various manners without departing from the spirits of the present disclosure.

In the above embodiment, the opener 10 releases the valve member 4 from the rotational biasing force of the first torsion spring 38 in the valve closing direction, when the actual value of the rotational angle is positioned at the angle, which is on the valve closing side of the reference angle “θb”. In other words, the rotational biasing force of the first torsion spring 38 is applied to the valve member 4 in the valve closing direction, so long as the actual value of the rotational angle is positioned on the valve opening side of the reference angle “θb”. Namely, the rotational biasing force is applied to the valve member 4 or the valve member 4 is released from the rotational biasing force with the boundary of the reference angle “θb”. However, the angle for the boundary should not be limited to the reference angle “θb”.

For example, the angle (“θb”+“εmax”) (FIG. 5), at which the actual value of the rotational angle reaches in the case of the maximum variation pattern (of the detected value) of the valve closing side, may be set as the angle for the boundary with respect to the rotational biasing force. Since the angle (“θb”+“εmax”) is positioned on the valve opening side of the reference angle “θb”, it is possible to suppress the abrasion and/or the deformation of the mechanical parts by the backlash, independently how the detected value of the rotational angle differs from the actual value (so long as the detected value differs from the actual value within the scope of the assumption).

What is claimed is:

1. An exhaust gas recirculation device for an internal combustion engine for recirculating a part of exhaust gas into an intake-air passage of the engine comprising:
a valve member rotatably arranged in an EGR passage for opening and/or closing the EGR passage by its rotational movement so as to control an EGR amount to be recirculated into the intake-air passage of the engine;
an annular seal ring provided at an outer periphery of the valve member so that the annular seal ring is rotated together with the valve member, the annular seal ring being in a sliding contact with a passage wall surface in a predetermined angular range of the valve member in order to seal a gap between the outer periphery of the valve member and passage wall surface;
a cylindrical member having a sliding wall surface, which forms a part of the passage wall surface and which is in the sliding contact with the annular seal ring of the valve member, the sliding wall surface being formed with a spherical surface which is formed as a part of a spherical surface having a spherical center corresponding to a rotational center of the valve member, the cylindrical member forming a flow-rate dead zone for a predetermined rotational range of the valve member in which the EGR amount is controlled at a minimum value when the valve member is rotated in any direction of a valve closing direction and a valve opening direction; and
a rotational angle sensor having a magneto-electric converting device for generating an original signal depending on a rotational angle of the valve member and synthesizing an output signal from the original signal in order to output the output signal,
wherein the rotational angle sensor memorizes a correlated characteristic between a signal value of the original signal and a signal value of the output signal, so that the rotational angle sensor synthesizes the output signal from the original signal by use of the correlated characteristic,
wherein each of the signal values of the original signal and the output signal has a boundary value for hall voltage on a valve closing side and a boundary value for output voltage on the valve closing side in connection with the correlated characteristic, the boundary value for the hall voltage on the valve closing side and the boundary value for the output voltage on the valve closing side are signal values of the original signal and the output signal in a condition in which the EGR amount is controlled at the minimum value,
wherein the signal value of the original signal and the signal value of the output signal correspond to each other in a one-to-one relationship in a range on a valve opening side of the boundary values,
wherein a signal value of the original signal at a reference angle is matched to the boundary value for the hall voltage on the valve closing side of the original signal, and
wherein the reference angle is set at such an angle, which is shifted by a predetermined angle in the valve closing side from an upper-limit angle of the dead zone,
wherein the upper-limit angle of the dead zone corresponds to the rotational angle of the valve member at a most valve-opening side of the flow-rate dead zone.

2. The exhaust gas recirculation device according to claim 1, further comprising:
an actuator for generating a rotational torque so as to rotate the valve member;
a first biasing member for generating a rotational biasing force so as to bias the valve member in the valve closing direction; and
an opener for releasing the valve member from the rotational biasing force of the first biasing member, when the rotational angle is positioned at an angle on the valve closing side of the reference angle.

3. The exhaust gas recirculation device according to claim 1, further comprising:
an actuator for generating a rotational torque so as to rotate the valve member;
a first biasing member for generating a rotational biasing force so as to bias the valve member in the valve closing direction;
an opener for releasing the valve member from the rotational biasing force of the first biasing member, when the rotational angle is positioned at an angle on the valve closing side of a predetermined releasing angle located in the flow-rate dead zone; and
a stopper for restricting a further rotation of the valve member in the valve closing direction, when the rotational angle of the valve member reaches at a restricting angle,
wherein the restricting angle is set at an angle, which is positioned on the valve closing side of not only the reference angle but also the predetermined releasing angle.

4. The exhaust gas recirculation device according to claim 1, further comprising:
an actuator for generating a rotational torque so as to rotate the valve member;
wherein the actuator is connected to a control unit, which transmits a command signal to the actuator so as to control the rotation of the valve member,
wherein the command signal is generated by the control unit based on a detected value of the rotational angle of the valve member,
wherein the detected value is figured out by the control unit based on the output signal of the rotational angle sensor,
wherein the flow-rate dead zone has an angular range larger than a changing range of the detected value of the rotational angle, and
wherein the changing range depends on;
changing factors of a sensor side, which are based on temperature characteristics of the rotational angle sensor, and
changing factors of a mechanical-parts side, which are based on abrasion and/or deformation of mechanical parts included in the actuator.
